(19) United States
(12) Patent Application Publication
(10) Pub. No.: US 2026/0316008 A1
(43) Pub. Date: Oct. 15, 2026

(54) CATALYZED PARTICULATE FILTER

(71) Applicant: BASF MOBILE EMISSIONS CATALYSTS LLC, Iselin, NJ (US)

(72) Inventors: Chunyu CHEN, Shanghai (CN); Attilio SIANI, Hannover (DE); Weiliang WANG, Shanghai (CN); Wenji SONG, Shanghai (CN)

(73) Assignee: BASF MOBILE EMISSIONS CATALYSTS LLC, Iselin, NJ (US)

(21) Appl. No.: 19/113,782

(22) PCT Filed: Sep. 26, 2023
(86) PCT No.: PCT/CN2023/121665

§ 371 Date: Mar. 20, 2025

(30) Foreign Application Priority Data
Sep. 27, 2022 (WO) PCT/CN2022/121777

(51) Int. Cl. B01D 53/94; B01J 23/63; B01J 35/00; B01J 35/56; B01J 37/02; F01N 3/035; F01N 3/10

(52) U.S. Cl. CPC B01D 53/945; B01J 23/63; B01J 35/19; B01J 35/56; B01J 37/0244; F01N 3/035; F01N 3/101; B01D 2255/1021; B01D 2255/1023; B01D 2255/1025; B01D 2255/2065; B01D 2255/2092; B01D 2255/9025; B01D 2255/908; B01D 2258/012; F01N 2510/0682

(57) ABSTRACT

A particulate filter, which comprises a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of the channels are outlet channels that are closed at the inlet end and open at the outlet end; and an in-wall TWC coating in the inlet channels and the outlet channels, comprising a platinum group metal component, an alumina-based refractory metal oxide and an oxygen storage component, wherein the in-wall TWC coating has a weight ratio of the alumina-based refractory metal oxide to the oxygen storage component in the range of 1:20 to 1:3, and wherein the in-wall TWC coating is free of any individual zirconium species and barium species.

### FIELD OF THE INVENTION

The present invention relates to a catalyzed particulate filter for treating an exhaust from a gasoline engine which comprises an in-wall TWC coating. The present invention also relates to a gasoline engine emission treatment system comprising the catalyzed particulate filter and a method for treating an exhaust from a gasoline engine.

### BACKGROUND OF THE INVENTION

Engine exhaust substantially consists of gaseous pollutants such as unburned hydrocarbons (HC), carbon monoxide (CO) and nitrogen oxides (NOx), and particulates. For gasoline engines, three-way conversion catalysts (hereinafter interchangeably referred to as TWC catalyst or TWC) for gaseous pollutants and filters for particulates are well-known aftertreatment means to ensure exhaust emissions to meet regulations.

In contrast to particulates generated by diesel lean burning engines, particulates generated by gasoline engines such as Gasoline Direct Injection engines, tend to be finer and in lesser quantities as known in the art. This is due to different combustion conditions of gasoline engines as compared to diesel engines. Particulate filters for treatment of an exhaust from gasoline engines (also known as gasoline particulate filters) have been developed for a few decades in order to effectively treating the exhaust, among which catalyzed gasoline particulate filters with combined catalytic activity and filtration function elicited a high degree of interest.

WO 2018/024547A1 describes a catalyzed particulate filter comprising a three-way conversion (TWC) catalytic material permeating walls of a particulate filter. Coating a TWC catalytic material onto or within a filter may result in an impact of backpressure. A particular coating scheme was proposed in the patent application to avoid unduly increasing backpressure while providing full three-way conversion functionality. It is required that the catalyzed particulate filter has a coated porosity that is less than an uncoated porosity of the particulate filter.

WO 2017/109514A1 describes a catalytic wall-flow monolith for use in an emission treatment system, wherein the monolith comprises a porous substrate and a TWC catalyst, wherein the TWC catalyst is distributed substantially throughout the porous substrate and wherein the TWC catalyst comprises (i) alumina; (ii) one or more platinum group metals; and (iii) an oxygen storage component (OSC), wherein the OSC comprises ceria or one or more mixed oxides comprising cerium and is present in a ratio by weight of OSC to alumina of from 65:35 to 85:15.

WO 2020/200394A1 describes a particulate filter which comprises a wall-flow filter of length L and two catalytically active coatings Y and Z, wherein the wall-flow filter comprises channels E and A that extend in parallel between a first and a second end of the wall-flow filter and are separated by porous walls which form surfaces OF and OA respectively, and wherein the channels E are closed at the second end and the channels A are closed at the first end, and the coatings Y and Z have the same oxygen storage components and the same carrier materials for noble metals.

The particulate filter is characterized in that coating Y is located in the channels E on the surfaces OE and extends from the first end of the wall flow filter over 55 to 90% of the length L, coating Z is located in the channels A on the surfaces OA and extends from the second end of the wall flow filter over 55 to 90% of the length L, and the coatings Y and Z contain aluminum oxide in a quantity of 20 to 70 wt %, relative to the total weight of the coating Y or Z, rhodium, palladium, or palladium and rhodium and one or more oxygen storage components in a quantity of 30 to 80 wt %, relative to the total weight of the coating Y or Z.

WO2020/200398A1 describes a particulate filter for removing particles, carbon monoxide, hydrocarbons, and nitrogen oxides out of the exhaust gas of combustion engines operated with a stoichiometric air/fuel mixture, comprising a wall-flow filter of length L and two different coatings Y and Z, wherein the wall-flow filter comprises channels E and A which extend in parallel between a first and a second end of the wall-flow filter and are separated by porous walls which form surfaces OE or OA, and wherein the channels E are closed at the second end and the channels A are closed at the first end, characterized in that the two coatings Y and Z are located in the porous walls and extend from the first end of the wall-flow filter over the entire length L and both comprise active alumina, at least one oxygen storage material, and at least one platinum group metal.

As gaseous and particulate emissions from gasoline engines are being subject to more stringent regulations, for example Euro 6 standard and China 6 standard, vehicle manufacturers, i.e., original equipment manufacturers (OEMs), require catalyzed gasoline particulate filters to have high catalytic activities at a low backpressure.

It is desirable to provide an improved catalyzed gasoline particulate filter having a higher catalytic activity and exhibiting a lower backpressure.

### SUMMARY OF THE INVENTION

The object of the present invention is to provide a catalyzed particulate filter for treatment of an exhaust from a gasoline engine, which has an improved catalytic performance. A further object of the present invention is to provide a particulate filter for treatment of an exhaust from a gasoline engine, which has an improved catalytic performance and exhibits a lower backpressure.

It has been surprisingly found that the object of the present invention was achieved by a particulate filter comprising an in-wall TWC coating containing a platinum group metal component and containing an alumina-based refractory metal oxide and an oxygen storage component (OSC) at a low alumina/OSC ratio, and being free of individual zirconium and barium species.

Accordingly, in a first aspect, the present invention provides a particulate filter, which comprises
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
an in-wall three-way conversion (TWC) coating in the inlet channels and the outlet channels, comprising a platinum group metal component, an alumina-based refractory metal oxide and an oxygen storage component (OSC),
wherein the in-wall TWC coating has a weight ratio of the alumina-based refractory metal oxide to the oxygen storage component in the range of 1:20 to 1:3, and
wherein the in-wall TWC coating is free of any individual zirconium species and barium species.

In a second aspect, the present invention provides a method for producing the particulate filter as described herein, which includes steps of
providing a slurry comprising mixing a platinum group metal component or a precursor thereof, an alumina-based refractory metal oxide and an oxygen storage component in a solvent, wherein no platinum group metal has been pre-fixed on the alumina-based refractory metal oxide and the oxygen storage component before the mixing, and
applying the slurry into inlet channels and outlet channels of a substrate,
to form an in-wall TWC coating.

In a third aspect, the present invention provides an exhaust treatment system comprising a particulate filter as described in the first aspect, preferably a particulate filter obtainable or obtained from the method as described in the second aspect, which is located downstream of a gasoline engine.

In a fourth aspect, the present invention provides a method for treating an exhaust from a gasoline engine, which includes contacting the exhaust with a particulate filter as described in the first aspect, preferably a particulate filter obtainable or obtained from the method as described in the second aspect, or an exhaust treatment system as described in the third aspect.

It has been found that the particulate filter according to the present invention could provide an improved catalytic performance compared with prior art counterparts. Further, improved backpressure characteristic was observed for the gasoline particulate filter.

### BRIEF DESCRIPTION OF THE DRAWINGS

FIG. 1 schematically depicts an external view of an exemplary wall-flow substrate having an inlet end and an outlet end.

FIG. 2 schematically depicts a longitudinal sectional view of an exemplary wall-flow substrate having a plurality of porous walls extending longitudinally from an inlet end to an outlet end of the substrate.

FIG. 3 schematically depicts a longitudinal sectional view of an exemplary in-wall TWC coating configuration of a gasoline particulate filter according to the present invention.

### DETAILED DESCRIPTION OF THE INVENTION

The present invention will be described in detail hereinafter. It is to be understood that the present invention may be embodied in many different ways and shall not be construed as limited to the embodiments set forth herein.

The singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consist of” or cognates may be embraced within “comprise” or cognates.

Herein, reference to “free of” is intended to mean no species as mentioned in its context has been intentionally added or used. However, it will be appreciated by those of skill in the art that a trace amount of the species may be present as an impurity originating from those intentionally used components.

Herein, the term “in-wall” within the context of a TWC coating is intended to mean a TWC coating with TWC components being intentionally loaded into pores of the porous walls of the substrate, although a minor amount, for example less than 50% by weight, preferably less than 30% by weight, more preferably less than 10% by weight of the TWC components may possibly be found on the surfaces of the porous walls in the coated channels. The meaning of the term “in-wall” is known in the art, for example as described in WO2017/109514A.

The terms for platinum group metal components, such as “palladium component”, “platinum component” and “rhodium component” are intended to describe the presence of respective platinum group metals in any possible valence state, which may be for example metal or metal oxide as the catalytically active form.

Herein, any reference to an amount of loading in the unit of “g/ft³” or “g/in³” is intended to mean the weight of the specified component, coat or layer per unit volume of the substrate, on which they are carried.

According to the first aspect of the present invention, a particulate filter is provided, which comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
an in-wall three-way conversion (TWC) coating in the inlet channels and the outlet channels,
comprising a platinum group metal component, an alumina-based refractory metal oxide and an oxygen storage component (OSC),
wherein the in-wall TWC coating has a weight ratio of the alumina-based refractory metal oxide to the oxygen storage component in the range of 1:20 to 1:3, and
wherein the in-wall TWC coating is free of any individual zirconium species and barium species.

The substrate as used herein refers to a structure that is suitable for withstanding conditions encountered in an exhaust stream from combustion engines and can function as a particulate filter by itself, on which one or more functional coatings, for example a catalytically active coating such as the TWC coating as described herein, and any further coatings may be carried.

The substrate comprises a plurality of porous walls extending longitudinally to form a plurality of parallel channels extending from an inlet end to an outlet end, wherein a quantity of the channels being inlet channels that are open at the inlet end and closed at the outlet end, and a quantity of channels different from the inlet channels are outlet channels that are closed at the inlet end and open at the outlet end. The configuration of the substrate requires the engine exhaust in the inlet channels to flow through the porous walls into the outlet channels to reach the outlet end of the substrate, which is also referred to as “wall-flow” substrate.

Generally, the substrate may have a honeycomb structure with alternate channels being blocked with a plug at opposite ends.

The porous walls of the substrate are generally made from ceramic materials or metal materials.

Suitable ceramic materials useful for constructing the substrate may include any suitable refractory materials, e.g., cordierite, mullite, cordierite-alumina, silicon carbide, silicon nitride, zirconia, mullite, spodumene, alumina-silica-magnesia, zirconium silicate, magnesium silicate, sillimanite, petalite, alumina, aluminum titanate and aluminosilicate. Typically, the porous walls of the substrate are made from cordierite or silicon carbide.

Suitable metallic materials useful for constructing the substrate may include heat resistant metals and metal alloys such as titanium and stainless steel as well as other alloys in which iron is a substantial or major component. Such alloys may contain one or more of nickel, chromium and aluminum, and the total amount of these metals may advantageously comprise at least 15% by weight of the alloy, for example 10 to 25% by weight of chromium, 3 to 8% by weight of aluminum, and up to 20% by weight of nickel. The alloys may also contain a small or trace amount of one or more metals such as manganese, copper, vanadium, titanium and the like. The surface of the metallic substrate may be oxidized at high temperature, e.g., 1000° C. or higher, to form an oxide layer on the surface of the substrate, improving the corrosion resistance of the alloy and facilitating adhesion of any coat layer to the metal surface.

The channels are blocked with plugs of a sealant material at the closed ends. Any suitable sealant materials may be used without any particular restriction.

The channels of the substrate can be of any suitable cross-sectional shape and size, such as circular, oval, sinusoidal, triangular, rectangular, square, hexagonal, trapezoidal or other polygonal shapes. The substrate may have up to 700 channels (i.e., cells) per square inch of cross section. For example, the substrate may have 100 to 500 cells per square inch (“cpsi”), typically 200 to 400 cpsi. The walls of the substrate may have various thicknesses, with a typical range of 2 mils to 0.1 inches. Preferably, the substrate has a number of inlet channels that is equal to the number of outlet channels, and the channels are evenly distributed throughout the substrate.

Generally, the porous walls of the substrate may have a mean pore size in the range of 10 to 30 microns (μm), for example 13 to 25 μm or 15 to 21 μm.

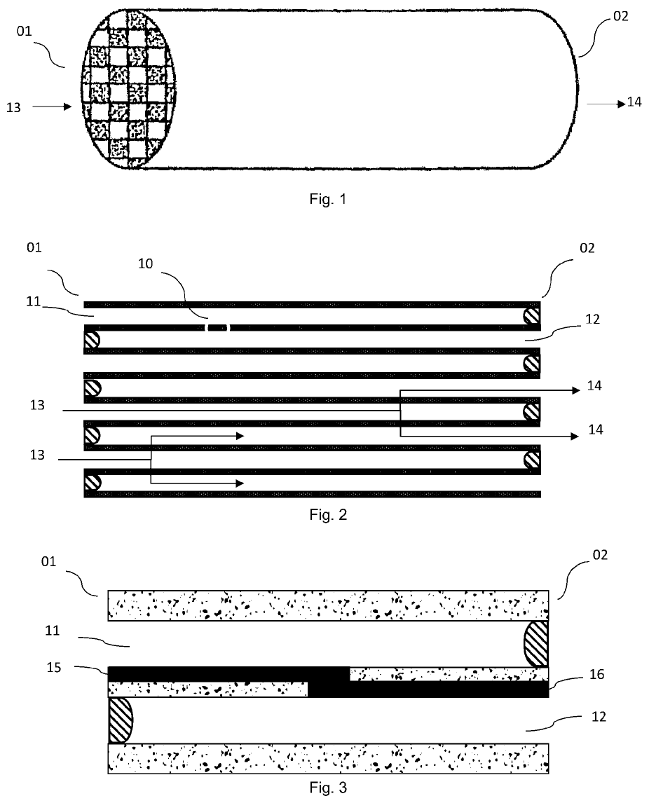

FIGS. 1 and 2 illustrate a typical wall-flow substrate comprising a plurality of inlet and outlet channels.

FIG. 1 schematically depicts an external view of the wall-flow substrate having an inlet end (01) from which an exhaust stream (13) enters the substrate and an outlet end (02) from which the treated exhaust stream (14) exits. Alternate channels are blocked with plugs to form a checkerboard pattern at the inlet end (01) as shown and an opposing checkerboard pattern at the outlet end (02) which is not shown.

FIG. 2 schematically depicts a longitudinal sectional view of the wall-flow substrate, comprising a first plurality of channels (11) which are open at the inlet end (01) and closed at the outlet end (02), and a second plurality of channels (12) which are open at the outlet end (02) and closed at the inlet end (01). The channels are preferably parallel to each other to provide a constant wall thickness between the channels. The exhaust stream (13) entering the first plurality of channels (11) from the inlet end has to diffuse through the porous walls (10) into the second plurality of channels to leave the substrate as the treated stream (14).

The in-wall TWC coating is present in both inlet channels and outlet channels, which may also be referred to as the in-wall TWC coating in the inlet channels and the in-wall TWC coating in the outlet channels.

In some embodiments, the in-wall TWC coating in the inlet channels extends from the inlet end of the channels along 50% to 100% of the axial length of the inlet channels; and the in-wall TWC coating in the outlet channels extends from the outlet end of the channels along 50% to 100% of the axial length of the outlet channels.

Preferably, the in-wall TWC coating in the inlet channels and the in-wall TWC coating in the outlet channels each extend along 50% to 75%, more preferably 50% to 60%, most preferably 50% to 55% of the axial length of respective channels.

It will be understood that the in-wall TWC coating in the inlet channels and the in-wall TWC coating in the outlet channels may overlap each other in length. FIG. 3 schematically depicts a longitudinal sectional view of such an in-wall TWC coating configuration on a substrate as illustrated in FIG. 1 and FIG. 2, wherein the in-wall TWC coating in the inlet channels (15) and the in-wall TWC coating in the outlet channels (16) extend with a certain length of overlapping.

In some particular embodiments, the in-wall TWC coating in the inlet channels and the in-wall TWC coating in the outlet channels extend for respective lengths with an overlapping length of no more than 10 mm.

Preferably, there is no layer of TWC components on the surfaces of the walls of the substrate except those optionally present in the overlapping areas of the in-wall TWC coatings in the inlet and outlet channels.

For the purpose of the present invention, the in-wall TWC coating in the inlet channels and the in-wall TWC coating in the outlet channels preferably have the same composition. More preferably, the in-wall TWC coating in the inlet channels and the in-wall TWC coating in the outlet channels are comprised in the particulate filter in same or substantially same loadings. Herein, the term “substantially same loadings” is intended to mean the difference between the loading of the in-wall TWC coating in the inlet channels and the loading of the in-wall TWC coating in the outlet channels is less than 20%, particularly less than 10%, preferably less than 5%, more preferably 1%, as calculated on the basis of the lower one of the two loadings.

There is no particular restriction to the platinum group metal (PGM) component comprised in the in-wall TWC coating. Typically, the PGM component may be a platinum (Pt) component, a palladium (Pd) component, a rhodium (Rh) component, a ruthenium (Ru) component, an osmium (Os) component, an iridium (Ir) component or any combinations thereof, among which a Pt component, a Pd component, a Rh component or any combinations thereof are particularly useful.

In some embodiments, the in-wall TWC coating comprises a combination of a Rh component, a Pt component and optionally a Pd component as the PGM component. Particularly, the in-wall TWC coating comprises a combination of a Rh component and a Pt component as the PGM component.

The in-wall TWC coating may comprise the PGM component at a total loading of 1.0 to 50.0 g/ft³ (i.e., about 0.04 to 1.8 g/L), or 5.0 to 20.0 g/ft³ (i.e., about 0.18 to 0.71 g/L), calculated as respective PGM elements.

Preferably, the Rh component is present in the in-wall TWC coating in an amount of 5% to 70%, preferably 10% to 60%, more preferably 20% to 50% relative to the total loading of the PGM component.

Herein, the term “alumina-based refractory metal oxide” refers to an oxide material comprising alumina which is optionally doped, encompassing alumina per se and doped alumina.

Suitable examples of the alumina-based refractory metal oxide include, but are not limited to high surface area alumina such as gamma alumina or a mixture of the gamma and delta phases of alumina which may also contain substantial amounts of eta, kappa and theta alumina phases; and doped alumina such as lanthana doped alumina, baria doped alumina, ceria doped alumina, zirconia doped alumina, ceria-zirconia doped alumina, lanthana-zirconia doped alumina, baria-lanthana doped alumina, baria-lanthana-neodymia doped alumina and any combinations thereof.

In some embodiments, the alumina-based refractory metal oxide in the in-wall TWC coating is selected from alumina, lanthana doped alumina, lanthana-zirconia doped alumina, ceria doped alumina, zirconia doped alumina, ceria-zirconia doped alumina or any combinations thereof, more preferably alumina, lanthana doped alumina or a combination thereof.

As well-known, the oxygen storage component (OSC) refers to an entity that has a multi-valence state and can actively react with oxidants such as oxygen or nitrogen oxides under oxidative conditions, or reacts with reductants such as carbon monoxide (CO) or hydrogen under reduction conditions. Typically, the OSC may be a reducible rare earth metal oxide such as ceria, or a composite oxide of ceria with one or more of lanthana, praseodymia, neodymia, europia, samaria, ytterbia, yttria, zirconia and hafnia, preferably a composite oxide of ceria with one or more of lanthana, praseodymia, neodymia, yttria and zirconia. Preferably, the oxygen storage component is selected from ceria, ceria-zirconia composite oxide and rare earth-stabilized ceria-zirconia composite oxide. It will be understood that the term “composite oxide” within the context of the OSC does not encompass physical mixtures of ceria with one or more other oxides.

In the in-wall TWC coating, the weight ratio of the alumina-based refractory metal oxide to the oxygen storage component is in the range of 1:20 to 1:3, preferably 1:15 to 1:4, more preferably 1:10 to 1:5, most preferably 1:10 to 1:7, for example 1:9 and 1:8 or any ratios therebetween. It has been surprisingly found by the inventors that the ratio of the alumina-based refractory metal oxide to the oxygen storage component in the in-wall TWC coating in the above ranges contributes to the superior catalytic performance of the particulate filter according to the present invention. The catalytic performance of the particulate filter will deteriorate if the said ratio is lower than 1:20 or higher than 1:3.

It was also surprisingly found by the inventors that the absence of any individual zirconium species and barium species in the in-wall TWC coating can contribute to the superior catalytic performance of the particulate filter according to the present invention. Herein, the individual zirconium species and barium species refer to zirconium species and barium species present as separate components as can be determined by Scanning Electron Microscope-Energy Dispersive Spectrometer (SEM-EDS) analysis. In other words, the in-wall TWC coating is free of any zirconium species and barium species other than those optionally contained in the alumina-based refractory metal oxide or the oxygen storage component.

The zirconium species may be any zirconium compounds, for example zirconium oxides, zirconium salts, or a combination thereof. The barium species may be any barium compounds, for example barium oxides, barium salts, or a combination thereof.

In some illustrative embodiments, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
an in-wall three-way conversion (TWC) coating in the inlet channels and the outlet channels, comprising a platinum group metal component, an alumina-based refractory metal oxide and an oxygen storage component (OSC),
wherein the alumina-based refractory metal oxide is selected from alumina, lanthana doped alumina, lanthana-zirconia doped alumina, ceria doped alumina, zirconia doped alumina, ceria-zirconia doped alumina or any combinations thereof, and the oxygen storage component is selected from ceria, or a composite oxide of ceria with one or more of lanthana, praseodymia, neodymia, europia, samaria, ytterbia, yttria, zirconia and hafnia,
wherein the in-wall TWC coating has a weight ratio of the alumina-based refractory metal oxide to the oxygen storage component in the range of 1:15 to 1:4, and
wherein the in-wall TWC coating is free of any individual zirconium species and barium species.

In above illustrative embodiments, the weight ratio of the alumina-based refractory metal oxide to the oxygen storage component is preferably in the range of 1:10 to 1:5, more preferably 1:10 to 1:7.

In some other illustrative embodiments, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
an in-wall three-way conversion (TWC) coating in the inlet channels and the outlet channels, comprising a platinum group metal component, an alumina-based refractory metal oxide and an oxygen storage component (OSC),
wherein the alumina-based refractory metal oxide is selected from alumina, lanthana doped alumina or a combination thereof, and the oxygen storage component is selected from a composite oxide of ceria with one or more of lanthana, praseodymia, neodymia, yttria and zirconia, wherein the in-wall TWC coating has a weight ratio of the alumina-based refractory metal oxide to the oxygen storage component in the range of 1:15 to 1:4, and
wherein the in-wall TWC coating is free of any individual zirconium species and barium species.

Preferably, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
an in-wall three-way conversion (TWC) coating in the inlet channels and the outlet channels, comprising a platinum group metal component, an alumina-based refractory metal oxide and an oxygen storage component (OSC),
wherein the alumina-based refractory metal oxide is selected from alumina, lanthana doped alumina or a combination thereof, and the oxygen storage component is selected from a composite oxide of ceria with one or more of lanthana, praseodymia, neodymia, yttria and zirconia, wherein the in-wall TWC coating has a weight ratio of the alumina-based refractory metal oxide to the oxygen storage component in the range of 1:10 to 1:5, and
wherein the in-wall TWC coating is free of any individual zirconium species and barium species.

More preferably, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
an in-wall three-way conversion (TWC) coating in the inlet channels and the outlet channels, comprising a platinum group metal component, an alumina-based refractory metal oxide and an oxygen storage component (OSC),
wherein the alumina-based refractory metal oxide is selected from alumina, lanthana doped alumina or a combination thereof, and the oxygen storage component is selected from a composite oxide of ceria with one or more of lanthana, praseodymia, neodymia, yttria and zirconia, wherein the in-wall TWC coating has a weight ratio of the alumina-based refractory metal oxide to the oxygen storage component in the range of 1:10 to 1:7, and
wherein the in-wall TWC coating is free of any individual zirconium species and barium species.

The particulate filter according to the present invention may comprise the in-wall TWC coating at a loading of 0.1 to 5.0 g/in³ (i.e., about 6.1 to 305.1 g/L), or 0.5 to 3.0 g/in³ (i.e., about 30.5 to 183.1 g/L), or 0.8 to 2 g/in³ (i.e., about 49 to 122 g/L).

The particulate filter may be housed within a shell having an inlet and an outlet for an exhaust stream, that may be operatively associated and in fluid communication with other parts of an exhaust system of an engine.

The in-wall TWC coating may be applied to the substrate by any known processes, for example by a conventional washcoating process comprising coating a slurry of TWC components into the channels of the substrate. The slurry for washcoating was usually prepared by pre-fixing the PGM component to support particles such as alumina-based refractory metal oxide through impregnation and/or thermal treatment, and then formulating into a solvent. It was believed that the pre-fixing can prevent a certain deactivation of the PGM component which can be observed when contacting with alumina-based refractory metal oxide.

However, it is surprisingly found by the inventors that the particulate filter comprising an in-wall TWC coating applied by washcoating a slurry prepared without pre-fixing the PGM component to the supports can provide significantly reduced exhaust emissions, as compared with a particulate filter comprising an in-wall TWC coating applied by washcoating a slurry prepared with pre-fixing the PGM component.

Accordingly, in the second aspect, the present invention provides a method for producing a particulate filter according to the first aspect of the present invention, which includes,
providing a slurry comprising mixing a platinum group metal component or a precursor thereof, an alumina-based refractory metal oxide and an oxygen storage component in a solvent, wherein no platinum group metal has been pre-fixed on the alumina-based refractory metal oxide and the oxygen storage component before the mixing, and
applying the slurry into inlet channels and outlet channels of a substrate,
to form an in-wall TWC coating.

Herein, the term “pre-fixed” and “pre-fixing” within the context of the platinum group metal (PGM) is intended to refer to PGM having been attached on supports such as the alumina-based refractory metal oxide or the oxygen storage component for example by impregnation (e.g., incipient wetness impregnation) and/or thermally treatment.

Generally, the slurry may be provided by mixing the platinum group metal component or a precursor thereof, the alumina-based refractory metal oxide and the oxygen storage component in an appropriate solvent such as water, to which an additive such as promoter, binder, stabilizer, viscosity modifier, pH adjustor, surfactant or any combinations thereof may be added. Before mixing the platinum group metal component or a precursor thereof, the alumina-based refractory metal oxide and the oxygen storage component, no platinum group metal has been pre-fixed on the alumina-based refractory metal oxide and the oxygen storage component. Such a process for proving the slurry may also be referred to as one-pot process.

In some particular embodiments of the method for producing the particulate filter, the slurry may be provided by mixing a Pt component or a precursor thereof and an oxygen storage component in a solvent to which an alumina-based refractory metal oxide and then a Rh component or a precursor thereof are added. Alternatively, the slurry may be provided by mixing a Rh component or a precursor thereof with an alumina-based refractory metal oxide in a solvent, to which an oxygen storage component and then a Pt component or a precursor thereof are added. In those embodiments, there is no particular restriction to the timing of mixing the additive, if used.

Suitable precursors of the platinum group metal component are for example soluble salts and/or complexes of the platinum group metal, such as ammine complex salts, hydroxyl salts, nitrates, carboxylic acid salts and ammonium salts, oxides and colloids of the platinum group metal.

The components for providing the slurry may be used in conventional forms, for example, as powder, sol, or a solution or suspension in a solvent. The solvent may be the same one as that of the slurry, particularly water. The slurry as applied to the substrate may have a conventional solid content, for example 15 to 60% by weight.

It will be understood that the additive, if used in the slurry, will not be any zirconium-containing substances or barium-containing substances. By avoiding use of such zirconium-containing substances or barium-containing substances in the slurry, an in-wall TWC coating free of any individual zirconium species and barium species as described in the first aspect of the present invention may be provided.

When necessary, the slurry may be comminuted/milled before being applied to the substrate in order to provide a suitable particle size for the in-wall coating. For example, the slurry may have a D₉₀ of less than 10 microns (μm), for example 7 μm or less, preferably 5 μm or less. Preferably, the slurry has a D₉₀ of greater than 0.4 microns (μm), for example 1 μm or greater, preferably 2 μm or greater. The comminution/milling may be accomplished in any conventional apparatuses such as ball mill, continuous Eiger mill, or the like.

The slurry generally has a pH of 2 to less than 9. When necessary, an inorganic or organic acid and/or base may be used as the pH adjustor.

The slurry may be applied to the substrate by dipping the substrate into the slurry, or otherwise coating onto the substrate, such that a desired loading of a coating will be deposited in walls of the substrate. When necessary, conventional means for removing the excess slurry, especially the remaining slurry on the surface of walls, from the substrate may be adopted, such as air blowing, applying vacuum, or the like. Thereafter, the coated substrate may be dried at a temperature in the range of from 100 to 300° C. and/or calcined at a temperature in the range of from 350 to 650° C. for a period of time, for example 1 to 3 hours. Drying and calcination are typically done in air. The coating, drying, and calcination processes may be repeated if necessary to achieve the final desired gravimetric amount of the TWC coating on the substrate. The loading of the TWC coating may be determined through calculation of the difference in the weights of the substrate before coating and the coated substrate upon calcination.

It will be understood that any features of the in-wall TWC coating as described generally or with preference hereinabove for the particulate filter in the first aspect are applicable here for the method according to the second aspect.

The particulate filter according to the first aspect or as prepared by the method according to the second aspect are particularly suitable for treating exhausts from gasoline engines.

Accordingly, in the third aspect, the present invention provides an exhaust treatment system which comprises a particulate filter as described in the first aspect, preferably a particulate filter obtainable or obtained from the method as described in the second aspect, which is located downstream of a gasoline engine.

In the fourth aspect, the present invention provides a method for treating an exhaust from a gasoline engine, which includes contacting the exhaust with a particulate filter as described in the first aspect, preferably a particulate filter obtainable or obtained from the method as described in the second aspect, or an exhaust treatment system as described in the third aspect.

### EMBODIMENTS

Various embodiments are listed below. It will be understood that the embodiments listed below may be combined with all aspects and other embodiments in accordance with the scope of the invention.

1. A particulate filter, which comprises
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
an in-wall TWC coating in the inlet channels and the outlet channels, comprising a platinum group metal component, an alumina-based refractory metal oxide and an oxygen storage component,
wherein the in-wall TWC coating has a weight ratio of the alumina-based refractory metal oxide to the oxygen storage component in the range of 1:20 to 1:3, and
wherein the in-wall TWC coating is free of any individual zirconium species and barium species.

2. The particulate filter according to Embodiment 1, wherein the weight ratio of the alumina-based refractory metal oxide to the oxygen storage component is in the range of 1:15 to 1:4, more preferably 1:10 to 1:5, most preferably 1:10 to 1:7.

3. The particulate filter according to Embodiment 1 or 2, wherein the alumina-based refractory metal oxide is selected from alumina, lanthana doped alumina, lanthana-zirconia doped alumina, ceria doped alumina, zirconia doped alumina, ceria-zirconia doped alumina or any combinations thereof, more preferably alumina, lanthana doped alumina or a combination thereof.

4. The particulate filter according to any of preceding Embodiments, wherein the oxygen storage component is selected from ceria, or a composite oxide of ceria with one or more of lanthana, praseodymia, neodymia, europia, samaria, ytterbia, yttria, zirconia and hafnia, preferably a composite oxide of ceria with one or more of lanthana, praseodymia, neodymia, yttria and zirconia.

5. The particulate filter according to any of preceding Embodiments, wherein the in-wall TWC coating in the inlet channels extends from the inlet end of the channels along 50% to 100% of the axial length of the inlet channels, and the in-wall TWC coating in the outlet channels extends from the outlet end of the channels along 50% to 100% of the axial length of the outlet channels.

6. The particulate filter according to Embodiment 5, wherein the in-wall TWC coating in the inlet channels and the in-wall TWC coating in the outlet channels extend along 50% to 75%, more preferably 50% to 60%, most preferably 50% to 55% of the axial length of respective channels.

7. The particulate filter according to any of preceding Embodiments, wherein the in-wall TWC coating in the inlet channels and the in-wall TWC coating in the outlet channels have the same composition.

8. The particulate filter according to any of preceding Embodiments, wherein the platinum group metal component is a Pt component, a Pd component, a Rh component or any combinations thereof.

9. The particulate filter according to any of preceding Embodiments, wherein the platinum group metal component is a combination of a Rh component, a Pt component and optionally a Pd component.

10. A method for producing the particulate filter according to any of preceding Embodiments, which includes steps of
providing a slurry comprising mixing a platinum group metal component or a precursor thereof, an alumina-based refractory metal oxide and an oxygen storage component in a solvent, wherein no platinum group metal has been pre-fixed on the alumina-based refractory metal oxide and the oxygen storage component before the mixing, and
applying the slurry into inlet channels and outlet channels of a substrate, to form an in-wall TWC coating.

11. The method according to Embodiment 10, wherein the slurry comprises an additive such as promoter, binder, stabilizer, viscosity modifier, pH adjustor, surfactant or any combinations thereof.

12. The method according to Embodiment 10 or 11, wherein the precursor of the platinum group metal component is selected from soluble salts, complexes, oxides and colloids of the platinum group metal.

13. The method according to any of Embodiments 10 to 12, which comprises drying and calcining after applying the slurry.

14. The method according to any of Embodiments 10 to 13, wherein the solvent is water.

15. The method according to any of Embodiments 10 to 14, wherein the slurry is provided by mixing a Pt component or a precursor thereof and an oxygen storage component in a solvent, to which an alumina-based refractory metal oxide and then a Rh component or a precursor thereof are added.

16. The method according to any of Embodiments 10 to 14, wherein the slurry is provided by mixing a Rh component or a precursor thereof with an alumina-based refractory metal oxide in a solvent, to which an oxygen storage component and then a Pt component or a precursor thereof are added.

17. An exhaust treatment system which comprises a particulate filter according to any of Embodiments 1 to 9, preferably a particulate filter obtainable or obtained from the method according to any of Embodiments 10 to 16, which is located downstream of a gasoline engine.

18. A method for treating an exhaust from a gasoline engine, which includes contacting the exhaust with a particulate filter according to any of Embodiments 1 to 9, preferably a particulate filter obtainable or obtained from the method according to any of Embodiments 10 to 16, or an exhaust treatment system according to Embodiment 17.

### EXAMPLES

Aspects of the present invention are more fully illustrated by the following examples, which are set forth to illustrate certain aspects of the present invention and are not to be construed as limiting thereof.

### I. Preparation of Catalyzed Gasoline Particulate Filter

### Example 1 (E1, Containing Ba/Zr, Pre-Fixing, Alumina/OSC Ratio of 0.37)

A particulate filter having an in-wall TWC coating was prepared by applying a TWC washcoat slurry into both inlet channels and outlet channels of a blank filter substrate (Corning® DuraTrap® GC). The blank filter substrate has a size of 118.4 mm (D)×127 mm (L), a volume of 1.4 L (about 85.4 in³), a cell density of 300 cells per square inch (cpsi), a wall thickness of 8 mils.

23.93 g of 16.39 wt % aqueous hexahydroxy platinic acid diethanolamine salt solution was mixed with 277 g of D.I. water and impregnated in planetary mixer (P-mixer) onto 693 g of La/Y doped ceria-zirconia composite oxide (OSC, 40% ceria, 5% lanthana, 5% yttria and balance of zirconia) to form a wet Pt/OSC powder while achieving incipient wetness. The wet Pt/OSC powder was mixed with 752 g of D.I. water, 55 g of barium nitrate and 39 g of 21.6 wt % aqueous zirconium nitrate solution to form a Pt/OSC slurry. The slurry was adjusted to a pH of 3.5 with nitric acid, and milled to a particle size D₉₀ of 4.5 μm.

20.29 g of 9.67 wt % aqueous rhodium nitrate solution was mixed with 179 g of D.I. water and impregnated in a planetary mixer (P-mixer) onto 256 g of a gamma alumina powder to form a wet Rh/alumina powder while achieving incipient wetness. The wet Rh/alumina powder was mixed with 160 g of D.I. water, 23 g of barium nitrate and 26 g of 21.6 wt % aqueous zirconium nitrate solution to form a Rh/alumina slurry. The slurry was adjusted to a pH of 3.5 with nitric acid, and milled to a particle size D₉₀ of 4.5 μm.

The Pt/OSC slurry and Rh/alumina slurry were combined as a final slurry, and then coated from the inlet end of the filter substrate with 50% of the target washcoat loading along 52% of the axial length of the filter, and from the outlet end of the filter substrate with rest 50% of the target washcoat loading along up to about 52% of the axial length of the filter. Then, the coated substrate was dried at a temperature of 150° C. for 1 h and then calcined at a temperature of 550° C. for 1 h.

The in-wall TWC coating was obtained with a washcoat loading of 1.48 g/in³ and a total PGM loading of 15.0 g/ft³ with a Pt/Rh ratio of 10/5.

### Example 2 (E2, Containing Ba/Zr, Pre-Fixing, Alumina/OSC Ratio of 0.30)

A particulate filter having an in-wall TWC coating was prepared from a blank filter substrate which is the same as the filter substrate of Example 1, by applying a TWC washcoat slurry into both inlet channels and outlet channels of the blank filter.

23.93 g of 16.39 wt % aqueous hexahydroxy platinic acid diethanolamine salt solution was mixed with 292 g of D.I. water and impregnated in planetary mixer (P-mixer) onto 730 g of La/Y doped ceria-zirconia composite oxide (OSC, 40% ceria, 5% lanthana, 5% yttria and balance of zirconia) to form a wet Pt/OSC powder while achieving incipient wetness. The wet Pt/OSC powder was mixed with 792 g of D.I. water, 55 g of barium nitrate and 39 g of 21.6 wt % aqueous zirconium nitrate solution to form a Pt/OSC slurry. The slurry was adjusted to a pH of 3.5 with nitric acid, and milled to a particle size D₉₀ of 4.5 μm.

20.29 g of 9.67 wt % aqueous rhodium nitrate solution was mixed with 153 g of D.I. water and impregnated in a planetary mixer (P-mixer) onto 219 g of a gamma alumina powder to form a wet Rh/alumina powder while achieving incipient wetness. The wet Rh/alumina powder was mixed with 120 g of D.I. water, 23 g of barium nitrate and 26 g of 21.6 wt % aqueous zirconium nitrate solution to form a Rh/alumina slurry. The slurry was adjusted to a pH of 3.5 with nitric acid, and milled to a particle size D₉₀ of 4.5 μm.

The Pt/OSC slurry and Rh/alumina slurry were combined as a final slurry, and then coated from the inlet end of the filter substrate with 50% of the target washcoat loading along 52% of the axial length of the filter, and from the outlet end of the filter substrate with rest 50% of the target washcoat loading along up to about 52% of the axial length of the filter. Then, the coated substrate was dried at a temperature of 150° C. for 1 h and then calcined at a temperature of 550° C. for 1 h.

The in-wall TWC coating was obtained with a washcoat loading of 1.48 g/in³ and a total PGM loading of 15.0 g/ft³ with a Pt/Rh ratio of 10/5.

### Example 3 (E3, Containing Ba/Zr, Pre-Fixing, Alumina/OSC Ratio of 0.20)

A particulate filter having an in-wall TWC coating was prepared from a blank filter substrate which is the same as the filter substrate of Example 1, by applying a TWC washcoat slurry into both inlet channels and outlet channels of the blank filter.

23.93 g of 16.39 wt % aqueous hexahydroxy platinic acid diethanolamine salt solution was mixed with 316 g of D.I. water and impregnated in planetary mixer (P-mixer) onto 791 g of La/Y doped ceria-zirconia composite oxide (OSC, 40% ceria, 5% lanthana, 5% yttria and balance of zirconia) to form a wet Pt/OSC powder while achieving incipient wetness. The wet Pt/OSC powder was mixed with 858 g of D.I. water, 55 g of barium nitrate and 39 g of 21.6 wt % aqueous zirconium nitrate solution to form a Pt/OSC slurry. The slurry was adjusted to a pH of 3.5 with nitric acid, and milled to a particle size D₉₀ of 4.5 μm.

20.29 g of 9.67 wt % aqueous rhodium nitrate solution was mixed with 111 g of D.I. water and impregnated in a planetary mixer (P-mixer) onto 158 g of a gamma alumina powder to form a wet Rh/alumina powder while achieving incipient wetness. The wet Rh/alumina powder was mixed with 99 g of D.I. water, 23 g of barium nitrate and 26 g of 21.6 wt % aqueous zirconium nitrate solution to form a Rh/alumina slurry. The slurry was adjusted to a pH of 3.5 with nitric acid, and milled to a particle size D₉₀ of 4.5 μm.

The Pt/OSC slurry and Rh/alumina slurry were combined as a final slurry, and then coated from the inlet end of the filter substrate with 50% of the target washcoat loading along 52% of the axial length of the filter, and from the outlet end of the filter substrate with rest 50% of the target washcoat loading along up to about 52% of the axial length of the filter. Then, the coated substrate was dried at a temperature of 150° C. for 1 h and then calcined at a temperature of 550° C. for 1 h.

The in-wall TWC coating was obtained with a washcoat loading of 1.48 g/in³ and a total PGM loading of 15.0 g/ft³ with a Pt/Rh ratio of 10/5.

### Example 4 (E4, Containing Ba/Zr, Pre-Fixing, Alumina/OSC Ratio of 0.12)

A particulate filter having an in-wall TWC coating was prepared from a blank filter substrate which is the same as the filter substrate of Example 1, by applying a TWC washcoat slurry into both inlet channels and outlet channels of the blank filter.

23.93 g of 16.39 wt % aqueous hexahydroxy platinic acid diethanolamine salt solution was mixed with 338 g of D.I. water and impregnated in planetary mixer (P-mixer) onto 846 g of La/Y doped ceria-zirconia composite oxide (OSC, 40% ceria, 5% lanthana, 5% yttria and balance of zirconia) to form a wet Pt/OSC powder while achieving incipient wetness. The wet Pt/OSC powder was mixed with 912 g of D.I. water, 55 g of barium nitrate and 39 g of 21.6 wt % aqueous zirconium nitrate solution to form a Pt/OSC slurry. The slurry was adjusted to a pH of 3.5 with nitric acid, and milled to a particle size D₉₀ of 4.5 μm.

20.29 g of 9.67 wt % aqueous rhodium nitrate solution was mixed with 72 g of D.I. water and impregnated in a planetary mixer (P-mixer) onto 103 g of a gamma alumina powder to form a wet Rh/alumina powder while achieving incipient wetness. The wet Rh/alumina powder was mixed with 68 g of D.I. water, 23 g of barium nitrate and 26 g of 21.6 wt % aqueous zirconium nitrate solution to form a Rh/alumina slurry. The slurry was adjusted to a pH of 3.5 with nitric acid, and milled to a particle size D₉₀ of 4.5 μm.

The Pt/OSC slurry and Rh/alumina slurry were combined as a final slurry, and then coated from the inlet end of the filter substrate with 50% of the target washcoat loading along 52% of the axial length of the filter, and from the outlet end of the filter substrate with rest 50% of the target washcoat loading along up to about 52% of the axial length of the filter. Then, the coated substrate was dried at a temperature of 150° C. for 1 h and then calcined at a temperature of 550° C. for 1 h.

The in-wall TWC coating was obtained with a washcoat loading of 1.48 g/in³ and a total PGM loading of 15.0 g/ft³ with a Pt/Rh ratio of 10/5.

### Example 5 (E5, Containing Ba/Zr, Pre-Fixing, Alumina/OSC Ratio of 0.12)

A particulate filter having an in-wall TWC coating was prepared from a blank filter substrate which is the same as the filter substrate of Example 1, by applying a TWC washcoat slurry into both inlet channels and outlet channels of the blank filter.

11.99 g of 16.39 wt % aqueous hexahydroxy platinic acid diethanolamine salt solution was mixed with 338 g of D.I. water and impregnated in planetary mixer (P-mixer) onto 846 g of La/Y doped ceria-zirconia composite oxide (OSC, 40% ceria, 5% lanthana, 5% yttria and balance of zirconia) to form a wet Pt/OSC powder while achieving incipient wetness. The wet Pt/OSC powder was mixed with 912 g of D.I. water, 55 g of barium nitrate and 39 g of 21.6 wt % aqueous zirconium nitrate solution to form a Pt/OSC slurry. The slurry was adjusted to a pH of 3.5 with nitric acid, and milled to a particle size D₉₀ of 4.5 μm.

20.33 g of 9.67 wt % aqueous rhodium nitrate solution was mixed with 72 g of D.I. water and impregnated in a planetary mixer (P-mixer) onto 103 g of a gamma alumina powder to form a wet Rh/alumina powder while achieving incipient wetness. The wet Rh/alumina powder was mixed with 68 g of D.I. water, 23 g of barium nitrate and 26 g of 21.6 wt % aqueous zirconium nitrate solution to form a Rh/alumina slurry. The slurry was adjusted to a pH of 3.5 with nitric acid, and milled to a particle size D₉₀ of 4.5 μm.

The Pt/OSC slurry and Rh/alumina slurry were combined as a final slurry, and then coated from the inlet end of the filter substrate with 50% of the target washcoat loading along 52% of the axial length of the filter, and from the outlet end of the filter substrate with rest 50% of the target washcoat loading along up to about 52% of the axial length of the filter. Then, the coated substrate was dried at a temperature of 150° C. for 1 h and then calcined at a temperature of 550° C. for 1 h.

The in-wall TWC coating was obtained with a washcoat loading of 1.48 g/in³ and a total PGM loading of 10.0 g/ft³ with a Pt/Rh ratio of 5/5.

### Example 6 (E6, Containing Ba/Zr, Pre-Fixing, Alumina/OSC Ratio of 0.05)

A particulate filter having an in-wall TWC coating was prepared from a blank filter substrate which is the same as the filter substrate of Example 1, by applying a TWC washcoat slurry into both inlet channels and outlet channels of the blank filter.

11.99 g of 16.39 wt % aqueous hexahydroxy platinic acid diethanolamine salt solution was mixed with 357 g of D.I. water and impregnated in planetary mixer (P-mixer) onto 892 g of La/Y doped ceria-zirconia composite oxide (OSC, 40% ceria, 5% lanthana, 5% yttria and balance of zirconia) to form a wet Pt/OSC powder while achieving incipient wetness. The wet Pt/OSC powder was mixed with 875 g of D.I. water, 55 g of barium nitrate and 39 g of 21.6 wt % aqueous zirconium nitrate solution to form a Pt/OSC slurry. The slurry was adjusted to a pH of 3.5 with nitric acid, and milled to a particle size D₉₀ of 4.5 μm.

20.33 g of 9.67 wt % aqueous rhodium nitrate solution was mixed with 32 g of D.I. water and impregnated in a planetary mixer (P-mixer) onto 45 g of a gamma alumina powder to form a wet Rh/alumina powder while achieving incipient wetness. The wet Rh/alumina powder was mixed with 22 g of D.I. water, 23 g of barium nitrate and 26 g of 21.6 wt % aqueous zirconium nitrate solution to form a Rh/alumina slurry. The slurry was adjusted to a pH of 3.5 with nitric acid, and milled to a particle size D₉₀ of 4.5 μm.

The Pt/OSC slurry and Rh/alumina slurry were combined as a final slurry, and then coated from the inlet end of the filter substrate with 50% of the target washcoat loading along 52% of the axial length of the filter, and from the outlet end of the filter substrate with rest 50% of the target washcoat loading along up to about 52% of the axial length of the filter. Then, the coated substrate was dried at a temperature of 150° C. for 1 h and then calcined at a temperature of 550° C. for 1 h.

The in-wall TWC coating was obtained with a washcoat loading of 1.48 g/in³ and a total PGM loading of 10.0 g/ft³ with a Pt/Rh ratio of 5/5.

### Example 7 (E7, Containing Ba/Zr, Pre-Fixing, No Alumina)

A particulate filter having an in-wall TWC coating was prepared from a blank filter substrate which is the same as the filter substrate of Example 1, by applying a TWC washcoat slurry into both inlet channels and outlet channels of the blank filter.

11.99 g of 16.39 wt % aqueous hexahydroxy platinic acid diethanolamine salt solution was mixed with 338 g of D.I. water and impregnated in planetary mixer (P-mixer) onto 846 g of La/Y doped ceria-zirconia composite oxide (OSC, 40% ceria, 5% lanthana, 5% yttria and balance of zirconia) to form a wet Pt/OSC powder while achieving incipient wetness. The wet Pt/OSC powder was mixed with 912 g of D.I. water, 55 g of barium nitrate and 39 g of 21.6 wt % aqueous zirconium nitrate solution to form a Pt/OSC slurry. The slurry was adjusted to a pH of 3.5 with nitric acid, and milled to a particle size D₉₀ of 4.5 μm.

20.29 g of 9.67 wt % aqueous rhodium nitrate solution was mixed with 41 g of D.I. water and impregnated in a planetary mixer (P-mixer) onto 103 g of La/Y doped ceria-zirconia composite oxide (OSC, 40% ceria, 5% lanthana, 5% yttria and balance of zirconia) to form a wet Rh/OSC powder while achieving incipient wetness. The wet Rh/OSC powder was mixed with 68 g of D.I. water, 23 g of barium nitrate and 26 g of 21.6 wt % aqueous zirconium nitrate solution to form a Rh/OSC slurry. The slurry was adjusted to a pH of 3.5 with nitric acid, and milled to a particle size D₉₀ of 4.5 μm.

The Pt/OSC slurry and Rh/OSC slurry were combined as a final slurry, and then coated from the inlet end of the filter substrate with 50% of the target washcoat loading along 52% of the axial length of the filter, and from the outlet end of the filter substrate with rest 50% of the target washcoat loading along up to about 52% of the axial length of the filter. Then, the coated substrate was dried at a temperature of 150° C. for 1 h and then calcined at a temperature of 550° C. for 1 h.

The in-wall TWC coating was obtained with a washcoat loading of 1.48 g/in³ and a total PGM loading of 10.0 g/ft³ with a Pt/Rh ratio of 5/5.

### Example 8 (E8, Containing Zr, Free of Ba, Pre-Fixing, Alumina/OSC Ratio of 0.12)

A particulate filter having an in-wall TWC coating was prepared from a blank filter substrate which is the same as the filter substrate of Example 1, by applying a TWC washcoat slurry into both inlet channels and outlet channels of the blank filter.

11.99 g of 16.39 wt % aqueous hexahydroxy platinic acid diethanolamine salt solution was mixed with 338 g of D.I. water and impregnated in planetary mixer (P-mixer) onto 846 g of La/Y doped ceria-zirconia composite oxide (OSC, 40% ceria, 5% lanthana, 5% yttria and balance of zirconia) to form a wet Pt/OSC powder while achieving incipient wetness. The wet Pt/OSC powder was mixed with 912 g of D.I. water, 39 g of 21.6 wt % aqueous zirconium nitrate solution to form a Pt/OSC slurry. The slurry was adjusted to a pH of 3.5 with nitric acid, and milled to a particle size D₉₀ of 4.5 μm.

20.33 g of 9.67 wt % aqueous rhodium nitrate solution was mixed with 72 g of D.I. water and impregnated in a planetary mixer (P-mixer) onto 103 g of a gamma alumina powder to form a wet Rh/alumina powder while achieving incipient wetness. The wet Rh/alumina powder was mixed with 68 g of D.I. water, 26 g of 21.6 wt % aqueous zirconium nitrate solution to form a Rh/alumina slurry. The slurry was adjusted to a pH of 3.5 with nitric acid, and milled to a particle size D₉₀ of 4.5 μm.

The Pt/OSC slurry and Rh/alumina slurry were combined as a final slurry, and then coated from the inlet end of the filter substrate with 50% of the target washcoat loading along 52% of the axial length of the filter, and from the outlet end of the filter substrate with rest 50% of the target washcoat loading along up to about 52% of the axial length of the filter. Then, the coated substrate was dried at a temperature of 150° C. for 1 h and then calcined at a temperature of 550° C. for 1 h.

The in-wall TWC coating was obtained with a washcoat loading of 1.48 g/in³ and a total PGM loading of 10.0 g/ft³ with a Pt/Rh ratio of 5/5.

### Example 9 (E9, Free of Ba and Zr, Pre-Fixing, Alumina/OSC Ratio of 0.12)

A particulate filter having an in-wall TWC coating was prepared from a blank filter substrate which is the same as the filter substrate of Example 1, by applying a TWC washcoat slurry into both inlet channels and outlet channels of the blank filter.

11.99 g of 16.39 wt % aqueous hexahydroxy platinic acid diethanolamine salt solution was mixed with 338 g of D.I. water and impregnated in planetary mixer (P-mixer) onto 846 g of La/Y doped ceria-zirconia composite oxide (OSC, 40% ceria, 5% lanthana, 5% yttria and balance of zirconia) to form a wet Pt/OSC powder while achieving incipient wetness. The wet Pt/OSC powder was mixed with 912 g of D.I. water to form a Pt/OSC slurry. The slurry was adjusted to a pH of 3.5 with nitric acid, and milled to a particle size D₉₀ of 4.5 μm.

20.33 g of 9.67 wt % aqueous rhodium nitrate solution was mixed with 72 g of D.I. water and impregnated in a planetary mixer (P-mixer) onto 103 g of a gamma alumina powder to form a wet Rh/alumina powder while achieving incipient wetness. The wet Rh/alumina powder was mixed with 68 g of D.I. water to form a Rh/alumina slurry. The slurry was adjusted to a pH of 3.5 with nitric acid, and milled to a particle size D₉₀ of 4.5 μm.

The Pt/OSC slurry and Rh/alumina slurry were combined as a final slurry, and then coated from the inlet end of the filter substrate with 50% of the target washcoat loading along 52% of the axial length of the filter, and from the outlet end of the filter substrate with rest 50% of the target washcoat loading along up to about 52% of the axial length of the filter. Then, the coated substrate was dried at a temperature of 150° C. for 1 h and then calcined at a temperature of 550° C. for 1 h.

The in-wall TWC coating was obtained with a washcoat loading of 1.48 g/in³ and a total PGM loading of 10.0 g/ft³ with a Pt/Rh ratio of 5/5.

### Example 10 (E10, Containing Ba/Zr, Pre-Fixing, Alumina/OSC Ratio of 0.12)

A particulate filter having an in-wall TWC coating was prepared from a blank filter substrate which is the same as the filter substrate of Example 1, by applying a TWC washcoat slurry into both inlet channels and outlet channels of the blank filter.

26.80 g of 16.39 wt % aqueous hexahydroxy platinic acid diethanolamine salt solution was mixed with 338 g of D.I. water and impregnated in planetary mixer (P-mixer) onto 846 g of La/Y doped ceria-zirconia composite oxide (OSC, 40% ceria, 5% lanthana, 5% yttria and balance of zirconia) to form a wet Pt/OSC powder while achieving incipient wetness. The wet Pt/OSC powder was mixed with 912 g of D.I. water, 55 g of barium nitrate and 39 g of 21.6 wt % aqueous zirconium nitrate solution to form a Pt/OSC slurry. The slurry was adjusted to a pH of 3.5 with nitric acid, and milled to a particle size D₉₀ of 4.5 μm.

15.10 g of 9.67 wt % aqueous rhodium nitrate solution was mixed with 72 g of D.I. water and impregnated in a planetary mixer (P-mixer) onto 103 g of a gamma alumina powder to form a wet Rh/alumina powder while achieving incipient wetness. The wet Rh/alumina powder was mixed with 68 g of D.I. water, 23 g of barium nitrate and 26 g of 21.6 wt % aqueous zirconium nitrate solution to form a Rh/alumina slurry. The slurry was adjusted to a pH of 3.5 with nitric acid, and milled to a particle size D₉₀ of 4.5 μm.

The Pt/OSC slurry and Rh/alumina slurry were combined as a final slurry, and then coated from the inlet end of the filter substrate with 50% of the target washcoat loading along 52% of the axial length of the filter, and from the outlet end of the filter substrate with rest 50% of the target washcoat loading along up to about 52% of the axial length of the filter. Then, the coated substrate was dried at a temperature of 150° C. for 1 h and then calcined at a temperature of 550° C. for 1 h.

The in-wall TWC coating was obtained with a washcoat loading of 1.98 g/in³ and total PGM loading of 20.0 g/ft³ with a Pt/Rh ratio of 15/5.

### Example 11 (E11, Containing Ba/Zr, One-Pot, Alumina/OSC Ratio of 0.12)

A particulate filter having an in-wall TWC coating was prepared from a blank filter substrate which is the same as the filter substrate of Example 1, by applying a TWC washcoat slurry into both inlet channels and outlet channels of the blank filter.

26.80 g of 16.39 wt % aqueous hexahydroxy platinic acid diethanolamine salt solution was mixed with 1360 g of D.I. water, then 846 g of La/Y doped ceria-zirconia composite oxide (OSC, 40% ceria, 5% lanthana, 5% yttria and balance of zirconia), 78 g of barium nitrate, 65 g of 21.6 wt % aqueous zirconium nitrate solution, 103 g of a gamma alumina powder, 15.10 g of 9.67 wt % aqueous rhodium nitrate solution were added to form a slurry. The slurry was adjusted to a pH of 3.5 with nitric acid, and milled to a particle size D₉₀ of 4.5 μm.

The slurry was then coated from the inlet end of the filter substrate with 50% of the target washcoat loading along 52% of the axial length of the filter, and from the outlet end of the filter substrate with rest 50% of the target washcoat loading along up to about 52% of the axial length of the filter. Then, the coated substrate was dried at a temperature of 150° C. for 1 h and then calcined at a temperature of 550° C. for 1 h.

The in-wall TWC coating was obtained with a washcoat loading of 1.98 g/in³ and total PGM loading of 20.0 g/ft³ with a Pt/Rh ratio of 15/5.

### Example 12 (E12, Containing Ba/Zr, Pre-Fixing, Alumina/OSC Ratio of 0.37)

A particulate filter having an in-wall TWC coating was prepared by applying a TWC washcoat slurry into both inlet channels and outlet channels of a blank filter substrate. The blank filter substrate has a size of 118.4 mm (D) (127 mm (L), a volume of 1.4 L (about 85.4 in³), a cell density of 300 cells per square inch (cpsi), a wall thickness of 8 mils.

47.60 g of 16.39 wt % aqueous hexahydroxy platinic acid diethanolamine salt solution was mixed with 277 g of D.I. water and impregnated in planetary mixer (P-mixer) onto 693 g of La/Y doped ceria-zirconia composite oxide (OSC, 40% ceria, 5% lanthana, 5% yttria and balance of zirconia) to form a wet Pt/OSC powder while achieving incipient wetness. The wet Pt/OSC powder was mixed with 752 g of D.I. water, 55 g of barium nitrate and 39 g of 21.6 wt % aqueous zirconium nitrate solution to form a Pt/OSC slurry. The slurry was adjusted to a pH of 3.5 with nitric acid, and milled to a particle size D₉₀ of 4.5 μm.

40.30 g of 9.67 wt % aqueous rhodium nitrate solution was mixed with 180 g of D.I. water and impregnated in a planetary mixer (P-mixer) onto 256 g of a gamma alumina powder to form a wet Rh/alumina powder while achieving incipient wetness. The wet Rh/alumina powder was mixed with 160 g of D.I. water, 23 g of barium nitrate and 26 g of 21.6 wt % aqueous zirconium nitrate solution to form a Rh/alumina slurry. The slurry was adjusted to a pH of 3.5 with nitric acid, and milled to a particle size D₉₀ of 4.5 μm.

The Pt/OSC slurry and Rh/alumina slurry were combined as a final slurry, and then coated from the inlet end of the filter substrate with 50% of the target washcoat loading along 52% of the axial length of the filter, and from the outlet end of the filter substrate with rest 50% of the target washcoat loading along up to about 52% of the axial length of the filter. Then, the coated substrate was dried at a temperature of 150° C. for 1 h and then calcined at a temperature of 550° C. for 1 h.

The in-wall TWC coating was obtained with a washcoat loading of 1.48 g/in³ and total PGM loading of 30.0 g/ft³ with a Pt/Rh ratio of 20/10.

### Example 13 (E13, Free of Ba and Zr, One-Pot, Alumina/OSC Ratio of 0.12)

A particulate filter having an in-wall TWC coating was prepared from a blank filter substrate which is the same as the filter substrate of Example 1, by applying a TWC washcoat slurry into both inlet channels and outlet channels of the blank filter.

47.60 g of 16.39 wt % aqueous hexahydroxy platinic acid diethanolamine salt solution was mixed with 1534 g of D.I. water, then 896 g of La/Y doped ceria-zirconia composite oxide (OSC, 40% ceria, 5% lanthana, 5% yttria and balance of zirconia), 111 g of a gamma alumina powder, 40.30 g of 9.67 wt % aqueous rhodium nitrate solution were added to form a slurry. The slurry was adjusted to a pH of 3.5 with nitric acid, and milled to a particle size D₉₀ of 4.5 μm.

The slurry was then coated from the inlet end of the filter substrate with 50% of the target washcoat loading along 52% of the axial length of the filter, and from the outlet end of the filter substrate with rest 50% of the target washcoat loading along up to about 52% of the axial length of the filter. Then, the coated substrate was dried at a temperature of 150° C. for 1 h and then calcined at a temperature of 550° C. for 1 h.

The in-wall TWC coating was obtained with a washcoat loading of 1.48 g/in³ and total PGM loading of 30.0 g/ft³ with a Pt/Rh ratio of 20/10.

### II. Performance Evaluation

### II.1 Oxygen Storage Capacity and Catalytic Activity

The particulate filters E1 to E13 were investigated for oxygen storage capacity and gas emissions. Prior to the evaluations, the samples were exothermically aged on an GM 8.1 L V8 engine at an inlet temperature of 875° C. for 100 hours. The samples same as E12 and E13 were also tested at fresh status without aging. The stationary oxygen storage capacity (SOSC) value of each sample was measured on an Audi 2.0 L turbo charged engine in the closed couple position with the inlet temperature of 580° C. and the flow rate of 50 kg/h. The measurement of gas emissions for each sample was performed under WLTC protocol on a Daimler 2.0 L engine in the closed couple position, and the THC, CO and NOx emissions downstream of each sample were measured. Lower values of the emissions indicate higher catalytic activity of the filter. The results of SOSC values and gas emissions are shown in Tables 1 to 4.

TABLE 1

| | TWC | Pt/Rh | Alumina/ | SOSC | Gas emissions | | |
|---|---|---|---|---|---|---|---|
| | loading | loading | OSC | value | (mg/km) | | |
| Example | (g/in³) | (g/ft³) | ratio | (mg) | THC | CO | NOx |
| E1 | 1.48 | 10/5 | 0.37 | 262 | 175 | 794 | 340 |
| E2 | | | 0.30 | 290 | 155 | 630 | 283 |
| E3 | | | 0.20 | 298 | 150 | 584 | 263 |
| E4 | | | 0.12 | 303 | 147 | 564 | 254 |
| E5 | 1.48 | 5/5 | 0.12 | 158 | 228 | 1094 | 537 |
| E6 | | | 0.05 | 152 | 230 | 1101 | 548 |
| E7 | | | 0 | 135 | 242 | 1123 | 589 |

It can be seen from the comparisons between E1 and E2 to E4 that the catalyzed particulate filters with an in-wall TWC coating having an alumina/OSC ratio of 0.12, 0.20 and 0.30 exhibit remarkably higher SOSC values and lower gas emissions (THC, CO and NOx) than the catalyzed particular filter with an in-wall TWC coating having an alumina/OSC ratio of 0.37.

It can also be seen from the comparison between E5 or E6 and E7 that the catalyzed particulate filters with an in-wall TWC coating having an alumina/OSC ratio of 0.12 and 0.05 exhibit remarkably higher SOSC value and lower gas emissions (THC, CO and NOx) than the catalyzed particulate filter with an in-wall TWC coating having an alumina/OSC ratio of 0, which is unexpected since the catalyzed particulate filters with an in-wall TWC coating having the alumina/OSC ratio of 0.12 and 0.05 even exhibit a higher SOSC value than the counterpart containing an oxygen storage component alone.

TABLE 2

| | TWC | Pt/Rh | Barium | Zirconium | SOSC | | | |
|---|---|---|---|---|---|---|---|---|
| | loading | loading | oxide | oxide | value | Gas emissions (mg/km) | | |
| Example | (g/in³) | (g/ft³) | (g/in³) | (g/in³) | (mg) | THC | CO | NOx |
| E5 | 1.48 | 5/5 | 0.07 | 0.02 | 158 | 228 | 1094 | 537 |
| E8 | | | 0 | 0.02 | 228 | 207 | 863 | 432 |
| E9 | | | 0 | 0 | 308 | 206 | 854 | 406 |

It can be seen from the comparison between E5 and E8 and the comparison between E8 and E9 that the absence of individual barium oxide or zirconium oxide from the in-wall TWC coating of the catalyzed particulate filter can result in improvements of the oxygen storage capacity and catalytic activity. Further, it can be seen that the absence of both individual barium oxide and zirconium oxide from the in-wall TWC coating can result in the highest SOSC value and the highest catalytic activity.

TABLE 3

| | TWC | Pt/Rh | Slurry | SOSC | Gas emissions | | |
|---|---|---|---|---|---|---|---|
| | loading | loading | prepa- | value | (mg/km) | | |
| Example | (g/in³) | (g/ft³) | ration | (mg) | THC | CO | NOx |
| E10 | 1.98 | 15/5 | Pre-fixing | 320 | 155 | 604 | 298 |
| E11 | | | One-pot | 370 | 142 | 506 | 246 |

The catalyzed particulate filter E10 was obtained from a slurry prepared via the conventional process comprising pre-fixing the PGM onto support, while the catalyzed particulate filter E11 was obtained from a slurry prepared via the one-pot process. Surprisingly, the catalyzed particulate filter E11 shows a higher SOSC value and a higher catalytic activity than the catalyzed particulate filter E10.

TABLE 4

| | | TWC | Pt/Rh | Alumina/ | | Barium | Zirconium |
|---|---|---|---|---|---|---|---|
| | | loading | loading | OSC | Slurry | oxide | oxide |
| Example | Status | (g/in³) | (g/ft³) | ratio | preparation | (g/in³) | (g/in³) |
| E12 | Fresh | 1.48 | 20/10 | 0.37 | Pre-fixing | 0.07 | 0.02 |
| E13 | | | | 0.12 | One-pot | 0 | 0 |
| E12 | Aged | | | 0.37 | Pre-fixing | 0.07 | 0.02 |
| E13 | | | | 0.12 | One-pot | 0 | 0 |

| | | | Gas emissions (mg/km) | | |
|---|---|---|---|---|---|
| Example | Status | SOSC value (mg) | THC | CO | NOx |
| E12 | Fresh | 526 | 53 | 151 | 47 |
| E13 | | 786 | 52 | 143 | 39 |
| E12 | Aged | 355 | 142 | 557 | 119 |
| E13 | | 481 | 137 | 521 | 102 |

It can be seen from the comparison between E12 and E13, that the catalyzed particulate filter having a reduced alumina/OSC ratio as prepared with a slurry from one-pot process in the absence of individual barium and zirconium species shows significantly improved oxygen storage capacity and catalytic activity, compared with the catalyzed particulate filter having a conventional alumina/OSC ratio as prepared with a slurry from conventional pre-fixing process in the presence of individual barium and zirconium species, at both fresh status and aged status.

II.2 Backpressure Increase Contributed by in-Wall TWC Coat

The particulate filters E12 and E13 were investigated for backpressure (BP), as measured by a SuperFlow SF-1020 Flowbench under a cold air flow at 600 m³/h. The backpressure of the blank filter substrates before coating were also measured under the same condition. The backpressure increase (ΔP) contributed by the in-wall TWC coating was calculated in accordance with the equation

ΔP=BP(coated)−BP(blank)

The results are shown in Table 5.

TABLE 5

| | BP (mbar) | | |
|---|---|---|---|
| Example | Blank Substrate | Coated Substrate | ΔP (mbar) |
| E12 | 49.8 | 54.6 | 4.8 |
| E13 | 49.8 | 53.2 | 3.4 |

The catalyzed particulate filter according to the present invention (E13) exhibits a much lower ΔP contributed by the in-wall TWC coating than the conventional catalyzed particulate filter (E12).

Although the invention herein has been described with reference to particular embodiments, it is to be understood that these embodiments are merely illustrative of the principles and applications of the present invention. It will be apparent to those of skill in the art that various modifications and variations can be made to the method and apparatus of the present invention without departing from the spirit and scope of the invention. Thus, it is intended that the present invention include modifications and variations that are within the scope of the appended claims and their equivalents.

1. A particulate filter, which comprises
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
an in-wall TWC coating in the inlet channels and the outlet channels, comprising a platinum group metal component, an alumina-based refractory metal oxide and an oxygen storage component,
wherein the in-wall TWC coating has a weight ratio of the alumina-based refractory metal oxide to the oxygen storage component in the range of 1:20 to 1:3, and
wherein the in-wall TWC coating is free of any individual zirconium species and barium species.

2. The particulate filter according to claim 1, wherein the weight ratio of the alumina-based refractory metal oxide to the oxygen storage component is in the range of 1:15 to 1:4, more preferably 1:10 to 1:5, most preferably 1:10 to 1:7.

3. The particulate filter according to claim 1, wherein the alumina-based refractory metal oxide is selected from alumina, lanthana doped alumina, lanthana-zirconia doped alumina, ceria doped alumina, zirconia doped alumina, ceria-zirconia doped alumina or any combinations thereof, more preferably alumina, lanthana doped alumina or a combination thereof.

4. The particulate filter according to claim 1, wherein the oxygen storage component is selected from ceria, or a composite oxide of ceria with one or more of lanthana, praseodymia, neodymia, europia, samaria, ytterbia, yttria, zirconia and hafnia, preferably a composite oxide of ceria with one or more of lanthana, praseodymia, neodymia, yttria and zirconia.

5. The particulate filter according claim 1, wherein the in-wall TWC coating in the inlet channels extends from the inlet end of the channels along 50% to 100% of the axial length of the inlet channels, and the in-wall TWC coating in the outlet channels extends from the outlet end of the channels along 50% to 100% of the axial length of the outlet channels.

6. The particulate filter according to claim 5, wherein the in-wall TWC coating in the inlet channels and the in-wall TWC coating in the outlet channels extend along 50% to 75%, more preferably 50% to 60%, most preferably 50% to 55% of the axial length of respective channels.

7. The particulate filter according to claim 1, wherein the in-wall TWC coating in the inlet channels and the in-wall TWC coating in the outlet channels have the same composition.

8. The particulate filter according to claim 1, wherein the platinum group metal component is a Pt component, a Pd component, a Rh component or any combinations thereof.

9. The particulate filter according to claim 1, wherein the platinum group metal component is a combination of a Rh component, a Pt component and optionally a Pd component.

10. A method for producing the particulate filter according to claim 1, which includes steps of
providing a slurry comprising mixing a platinum group metal component or a precursor thereof, an alumina-based refractory metal oxide and an oxygen storage component in a solvent, wherein no platinum group metal has been pre-fixed on the alumina-based refractory metal oxide and the oxygen storage component before the mixing, and
applying the slurry into inlet channels and outlet channels of a substrate, to form an in-wall TWC coating.

11. The method according to claim 10, wherein the slurry comprises an additive such as promoter, binder, stabilizer, viscosity modifier, pH adjustor, surfactant or any combinations thereof.

12. The method according to claim 10, wherein the precursor of the platinum group metal component is selected from soluble salts, complexes, oxides and colloids of the platinum group metal.

13. The method according to claim 10, which comprises drying and calcining after applying the slurry.

14. The method according to claim 10, wherein the solvent is water.

15. The method according to claim 10, wherein the slurry is provided by mixing a Pt component or a precursor thereof and an oxygen storage component in a solvent, to which an alumina-based refractory metal oxide and then a Rh component or a precursor thereof are added.

16. The method according to claim 10, wherein the slurry is provided by mixing a Rh component or a precursor thereof with an alumina-based refractory metal oxide in a solvent, to which an oxygen storage component and then a Pt component or a precursor thereof are added.

17. An exhaust treatment system which comprises a particulate filter according to claim 1, preferably a particulate filter obtainable or obtained from the method of providing a slurry comprising mixing a platinum group metal component or a precursor thereof, an alumina-based refractory metal oxide and an oxygen storage component in a solvent, wherein no platinum group metal has been pre-fixed on the alumina-based refractory metal oxide and the oxygen storage component before the mixing, and
applying the slurry into inlet channels and outlet channels of a substrate, to form an in-wall TWC coating, which is located downstream of a gasoline engine.

18. A method for treating an exhaust from a gasoline engine, which includes contacting the exhaust with a particulate filter
by providing a slurry comprising mixing a platinum group metal component or a precursor thereof, an alumina-based refractory metal oxide and an oxygen storage component in a solvent, wherein no platinum group metal has been pre-fixed on the alumina-based refractory metal oxide and the oxygen storage component before the mixing, and
applying the slurry into inlet channels and outlet channels of a substrate, to form an in-wall TWC coating.
